(19) United States
(12) Patent Application Publication
(10) Pub. No.: US 2005/0219033 A1
(43) Pub. Date: Oct. 6, 2005

(54) Fuse status indicator for fuse cartridge

(76) Inventors: Sergio Bortolloni, Sesto San Giovanni (IT); Giuseppe Zanaglio, Paderno Dugnano (IT); Miriam Biagini, Saronno (IT); Massimo Baldo, Paderno Dugnano (IT); Karen Hecht, Shorewood, WI (US); Theodore J. Houck III, Milwaukee, WI (US)

Correspondence Address: Susan M. Donahue;Rockwell Automation, Inc., 704-P, 1201 South Second Street, Milwaukee, WI, 53204-2496, US

(21) Appl. No.: 10/812,705

(22) Filed: Mar. 30, 2004

(51) Int. Cl. H01H 85/30

(52) U.S. Cl. 337/241

(57) ABSTRACT

A fuse status indicator assembly (40, 41, 42) for insertion in an opening (31) in a side wall of the fuse cartridge (20a, 20b, 20c) including a fuse (35) has a snap-in removable carrier (41) in the event that the bulb (42) has burned out and must be replaced. Labels (22) are attached to the fuse cartridges (20a, 20b, 20c) to identify the circuits and ratings of the fuses (35).

### CROSS-REFERENCE TO RELATED APPLICATIONS

Not Applicable

STATEMENT REGARDING FEDERALLY SPONSORED RESEARCH

Not Applicable

### TECHNICAL FIELD

The field of the invention is fuse cartridges for fused disconnect switches of the type used in enclosures for electrical control equipment.

### BACKGROUND ART

In factory automation and other commercial applications requiring control of motors and other electrical equipment, it is typical to mount electrical controls in a cabinet-styled enclosure. Power to the electrical devices in the cabinet is supplied through a fused or non-fused disconnect switch. Fuses are often included in a cartridge which can be inserted and removed from a switch body to replace the fuse. It is beneficial to include fuse status indicators to indicate the condition of the fuse.

### SUMMARY OF THE INVENTION

The invention relates to a fuse status indicator assembly for insertion in a removable fuse cartridge, which is used, for example, in a power disconnect switch. The indicator enables a service person to quickly identify a blown fuse condition before removing a fuse cartridge. The fuse status indicator is provided on a removable carrier in the event that the indicator itself has burned out and must be replaced.

It is one object of the invention to provide a modular fuse status indicator assembly that is compact and easy to install and remove on a fuse cartridge for a disconnect switch assembly. This enhances the serviceability of the equipment.

As an additional aid, labeling can be placed on the fuse cartridge to provide additional information about the fuse being serviced, so that a proper replacement part is readily available.

These and other objects and advantages of the invention will be apparent from the description that follows and from the drawings which illustrate embodiments of the invention, and which are incorporated herein by reference.

### BRIEF DESCRIPTION OF THE DRAWINGS

FIG. 1 is a perspective, partially exploded view of a disconnect switch assembly with a fuse status indicator of the present invention;

FIG. 2 is an exploded, perspective view of one of the cartridges seen in FIG. 1;

FIG. 3 is a detail perspective view of an interior of the fuse cartridge of FIG. 2;

FIG. 4 is section view taken in the plane indicated by line 4-4 in FIG. 1; and

FIG. 5 is section view taken in the plane indicated by line 5-5 in FIG. 1.

### DETAILED DESCRIPTION

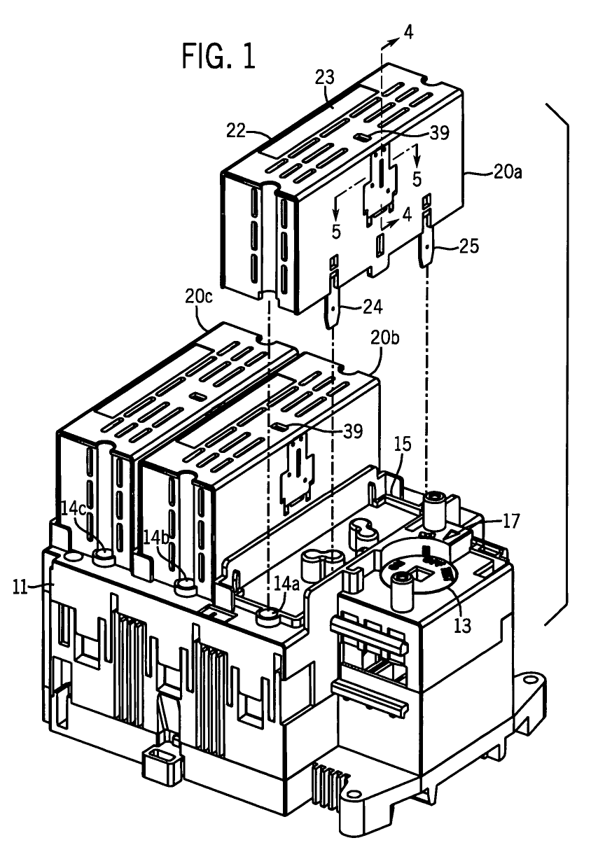

FIG. 1 illustrates a disconnect switch 10 which is mounted in the interior of an enclosure of the type disclosed in our co-pending U.S. Pat. Application, entitled “Rotary Service Switch for the Interior of Electrical Enclosures having a Disconnect Switch,” filed on even date herewith, the disclosure of which is hereby incorporated by reference.

The disconnect switch 10 includes a switch body 11. Electrical power is received through one set of input terminals (not shown) connecting to input terminals along the top of the disconnect switch body 11. From there, power is routed through fuse cartridges 20a, 20b and 20c. Output terminals 14a, 14b and 14c (FIG. 1) are provided along the bottom of the switch body 11, to conduct power to the other equipment in the cabinet (not shown). The electrical power is typically three-phase power and the disconnect switch 10 has at least three identical cartridges 20a, 20b, 20c (FIG. 12) corresponding to switch poles or sub-circuits and is rated for three-phase operation, although single-phase operation is also possible.

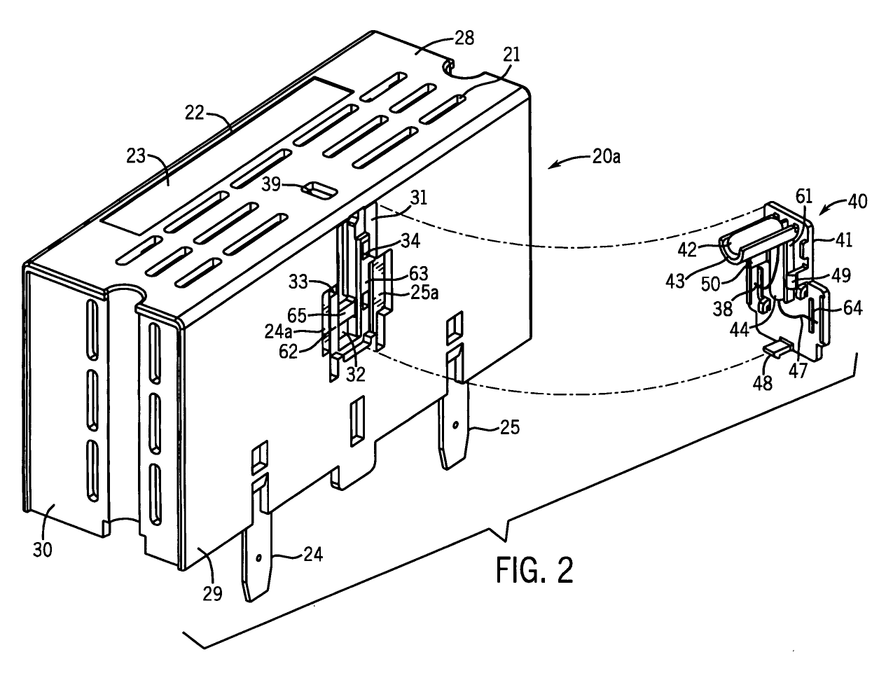

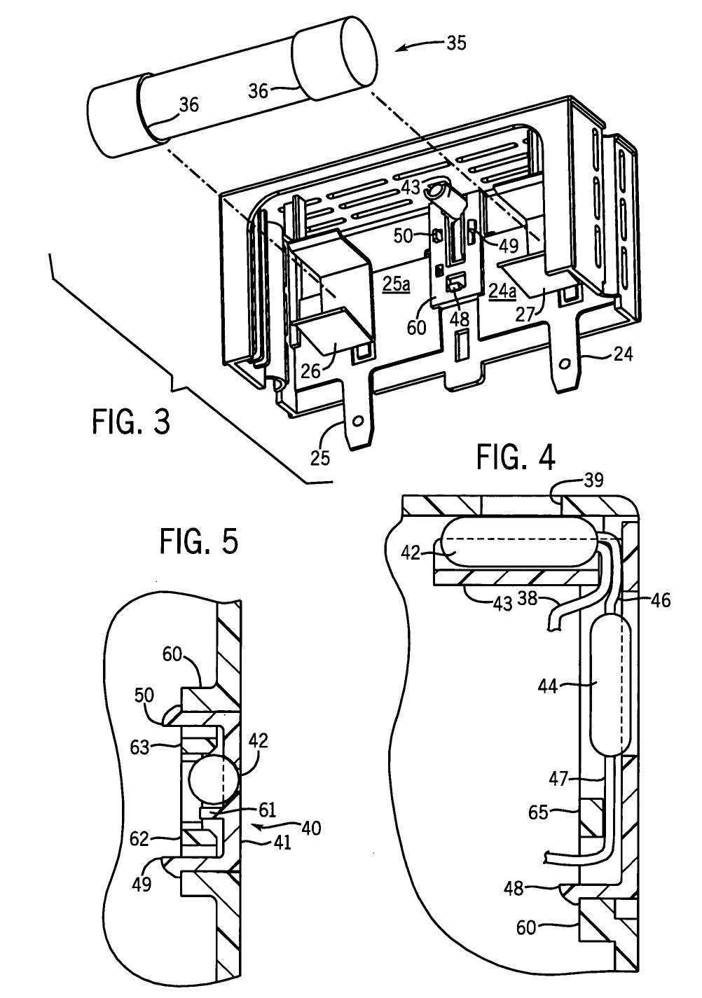

The disconnect switch 10 of the present invention is provided in sizes with ratings of 60 amps, 30 amps and smaller. The fuses 35, one of which is seen in FIG. 3, are provided with suitable ratings for handling current overloads or faults. The size, type and ratings of the fuses are provided on labels 23 attached to the outside the cartridges 20a, 20b, 20c as exemplified in FIGS. 1 and 2. The labels 23 do not cover the full face of each cartridge, so as to allow room for vents 21 and an indicator window 39.

Referring again to FIG. 1, the disconnect switch 10 has a rotary actuating mechanism 13 with three positions, “ON”, “OFF” and “TEST”, as shown in FIG. 1. In the “OFF” position (shown in FIG. 1 with the “OFF” legend opposite the arrow indicator 17) , the switch contacts in the disconnect switch are open and power is disconnected. When the mechanism 13 is rotated so that the “ON” legend is opposite indicator 17, the rotational action is translated to another rotational member (not shown) extending transversely through the switch body 11 and when this member is moved, the switch contacts are closed with a snap action. This mechanism 13 is known from prior disconnect switches and is not part of the present invention.

The fuse cartridges 20a, 20b and 20c are attached and detached from the switch body 11, the fuse cartridges having housings that are received in snap-in seats 15 (FIG. 1) formed on the switch body 11. Each cartridge also has electrical stab connectors 24 and 25 which are received in mating electrical sockets (not shown) which are electrically connected to the input and output terminals to form circuit paths through the fused cartridges.

Referring to FIG. 2, each cartridge, represented by cartridge 20a, has a housing with front wall 28, two side walls 29 and two end walls 30. On the front wall 28 is a recess 22 for receiving an adhesively attached label 23 along the left half portion. The label 23 provides information about the electrical parameters and circuit in which the fuse is situated, so that it can be expeditiously replaced when necessary. The right half portion of the front wall 28 is formed with elongated vents 21 and a relatively shorter, transversely oriented aperture 39 for viewing a blown fuse indicator bulb 42. In the right side wall as seen in FIG. 2, there is an opening 31 for receiving a fuse status indicator assembly 40 that includes the bulb 42.

The fuse status indicator assembly 40 (FIG. 2) has a base 41 with a generally planar back portion having a shape for keyed insertion into an opening 31 in the fuse cartridge side wall 29. The base is preferably made of a molded plastic material with integrally formed, resilient, barbed retaining fingers 48, 49, 50 for insertion into apertures 32, 33, 34, seen in FIGS. 2, 3, 4 and 5. A planar retainer member 60 (FIG. 3) which may be integrally formed with the wall 29 forms the apertures 32, 33, 34 for receiving the fingers 48, 49 and 50. The barbed fingers 48, 49 and 50 will release in response to a withdrawal force coupled with a lifting action.

The fuse indicator assembly 40 also has a first trough-shaped support 43 (FIGS. 3 and 4) projecting into the fuse cartridge 20a from the base 41 for supporting the fuse status indicator 42 in position so as to be seen from a front of the fuse cartridge 20a through aperture 39 (FIG. 4). The fuse status indicator 42 is preferably a neon bulb, but other types of illumination devices may be used.

In this embodiment, a resistor 44 is connected in series with the bulb 42 using leads 46 and 47, to limit current through the bulb, which is much less than through the fuse 35. The resistor 44 is contained side-to-side between ribs 62, 63 (FIGS. 2 and 5) formed just interior of the side wall 29 and front-to-back between the back member 41 and the retaining member 60. These ribs 62, 63, provide the apertures 33, 34 seen in FIG. 2 for receiving the barbed fingers 49, 50. Cross member 65 (FIGS. 2 and 4) extends across the top of opening 32 for receiving barbed finger 48 and also helps retain and route lead 46 as seen in FIG. 4. An additional rib 61 (FIGS. 2, 5) is formed on the back portion of base 41 to locate the resistor 43, which is comparable in size to the bulb 42.

As seen in the interior of the cartridge in FIG. 3, the stab connectors 24, 25 are connected to fuse clips 26, 27, which receive fuse terminals 36 on opposing ends of the fuse 35, when the fuse 35 is installed, thus forming a circuit. The stab connectors 24, 25 also have contact portions 24a, 25a which extend laterally under the edges of retaining member 60 are seen in FIG. 2 through the opening 31. The fuse indicator circuit has leads 38, 47 seen in FIG. 4 which are wired in series with the fuse 35, so that when the fuse blows, the indicator 42 will lose its illumination, indicating a blown fuse. When a fuse is blown, a fuse link in the fuse is interrupted. The stripped ends of wires 38, 47 are pressed against the contact portions 24a, 25a by ribs 64 on the carrier base 41 seen in FIG. 2, when the assembly 40 is inserted in the cartridge 20a to complete the fuse indicator circuit.

This has been a description of several preferred embodiments of the invention. It will be apparent that various modifications and details can be varied without departing from the scope and spirit of the invention, and these are intended to come within the scope of the following claims.

1. A fuse status indicator assembly comprising:
a base having a generally planar back portion and having a shape for insertion into an opening in a fuse cartridge;
retainers for holding the base in the opening in the fuse cartridge;
a fuse status indicator electrically connected to at least one fuse contact, said fuse status indicator being illuminated so long as a fuse disposed in said fuse contacts is not blown; and
a first support projecting into the fuse cartridge from the base for supporting the fuse status indicator in position so as to be seen from a front of the fuse cartridge.

2. The fuse status indicator of claim 1, wherein the fuse status indicator is a neon bulb.

3. The fuse status indicator of claim 1, further comprising:
a second support disposed on an inwardly facing side of the base for locating a circuit element that is electrically connected to the fuse status indicator.

4. The fuse status indicator of claim 3, wherein the circuit element is a resistor.

5. The fuse status indicator of claim 1, further comprising a label for attachment to the fuse cartridge to indicate the electrical parameters of a fuse in the fuse cartridge.

6. The fuse status indicator assembly of claim 1, wherein the retainer further comprises barbed members extending forward from the back portion of the base, and a retainer member for location inside the cartridge to receive and retain the barbed members.

7. A fuse status indicator assembly comprising:
a base having a generally planar back portion having a shape for keyed insertion into an opening of corresponding shape in a fuse cartridge;
snap-in retainers for holding the base in the opening in the fuse cartridge, while allowing removal of the assembly in response to a withdrawal force;
a fuse status indicator electrically connected to at least one fuse contact, said fuse status indicator being illuminated so long as a fuse connecting said fuse contacts is not blown;
a first support projecting into the fuse cartridge from the base for supporting the fuse status indicator in position so as to be seen from a front of the fuse cartridge; and
means for urging circuit connections to the fuse status indicator into contact with exposed contacts in a cartridge which are covered by the base when the fuse contact assembly is installed.

8. The fuse status indicator assembly of claim 7 in which the fuse status indicator is electrically connected to a current limiting element that is also supported on the base.

9. A fuse cartridge assembly, comprising:
a casing having an opening in which contacts to fuse clips are exposed;
a retainer disposed behind the opening with apertures for receiving fastening members; and
a fuse status indicator assembly comprising:
a base having a generally planar back portion having a shape for insertion into the opening in the casing;
snap-in fastening members for insertion into the apertures in the retainer for holding the base in the opening in the casing, while allowing removal of the assembly in response to a withdrawal force; and
a fuse status indicator supported on the back portion and connected to leads for connection to the fuse contacts, said fuse status indicator being illuminated so long as a fuse connecting said fuse contacts is not blown.
